(19) United States
(12) Patent Application Publication
(10) Pub. No.: US 2002/0093464 A1
(43) Pub. Date: Jul. 18, 2002

(54) Information display apparatus

(76) Inventor: Bradford S. Warren, (US)

Correspondence Address: FULBRIGHT & JAWORSKI, LLP, 1301 MCKINNEY, SUITE 5100, HOUSTON, TX, 77010-3095, US

(21) Appl. No.: 09/867,143

(22) Filed: May 29, 2001

Related U.S. Application Data
(60) Provisional application No. 60/207,599, filed on May 26, 2000.

(51) Int. Cl. G09G 5/00

(52) U.S. Cl. 345/5

(57) ABSTRACT

The present invention relates to an apparatus for displaying information. The information display apparatus includes panels adapted to interlock so as to form a triangular frame that rotates about a supporting pole. The triangular paneled frame comprises an illuminating source and/or supports self-illuminating panels. The display is easily assembled onto existing supports.

The present invention claims priority to Provisional Application No. 60/207,599, which was filed by the Applicant on May 26, 2000.

### FIELD OF INVENTION

The present invention relates to an apparatus for use in displaying information, and more particularly, to a rotating display apparatus readily installed on existing supports, including interchangeable information display surfaces and internal illumination.

### BACKGROUND

Current displays providing general map information, such as street signs, transportation signs illustrating train and bus routes, and the like, are generally presented in a one dimensional format. For instance, signs providing bus route information are normally presented in single fixed panel format. The panel is rigidly mounted atop a vertical support, walled surface, or inside a framed case. Signs of this type are also routinely placed above head level, which are not easily accessible. Traditional signs are therefore frequently not adequate for the presentation of information to an impaired individual. More particularly, map information with Braille lettering is generally not available when the information is positioned atop a vertical pole or like support.

There is therefore a need for an information display that presents information in an accessible format, which can be seen and understood by an individual who is handicapped. This need is further illustrated by the passage of the American Disabilities Act (“ADA”), which was signed into law on Jul. 26, 1990. A fundamental goal of this law is to provide people with disabilities with access to civic life. This goal is to ensure that all people with disabilities can take part in, and benefit from, the programs and services of State and local governments. To fulfill this goal, access must be provided to all individuals. For example, curb ramps provide access to streets and sidewalks, which is a basic city service. Thus, the ADA requires that all individuals have access to streets and sidewalks, as well as their use. Navigating city streets with impaired vision, however, is complicated by the fact that street and transportation signs do not provide Braille lettering, are too high to read, and do not provide sufficient illumination at night.

The present invention addresses the need to provide individuals, handicapped or not, with the information necessary to navigate along pedestrian routes, or mass transit routes, such as bus and train transportation.

### SUMMARY OF THE INVENTION

The present invention is a rotating display assembly for providing pedestrian information, such as street maps and transportation routes, to the general population as well as sight impaired individuals. The display assembly is easily and readily installed on new or existing support members, including sign poles, light poles, and utility poles. The display assembly is provided with a mount configured to securedly fasten to the support pole, and provide the display assembly with rotating capabilities. The invention is provided with attachment brackets adapted to rotatably engage the support mounts. In this way, the bracket is able to rotate about the mount in a circular fashion. The support bracket is further attached to display support panels so as to form a geometrically shaped frame enclosing at least a portion of the support member. Preferably, the display assembly comprises a triangular frame forming an outer display surface, and inner compartment. The frame is rotatable about the support member, wherein the outer panels display information to the user. The frame is constructed of extruded aluminum, fabricated sheet metal, cast aluminum, or any combination thereof.

The frame includes a support panel adapted to receive varying display panels. The frame is further provided with an easily removable top cover, which supports the easy exchange of display panels as may be necessary. Display panels are either self-illuminating (i.e., photoiluminescent) or illuminated by a light source contained within the display frames inner compartment. Display panels display information in various formats. For instance, illuminating graphics, Braille letter, and traditional information formats are used.

It is therefore an object of the present invention to provide a rotating sign that requires low maintenance, is easily installed, and provides information through a wide range of display formats.

It is an object of the present invention to provide a rotating sign having multiple informational display panels.

Another object of the present invention is to provide a rotating sign that is user friendly, offering multiple display formats suitable for persons who are sight impaired, such as Braille lettering.

Yet another object of the present invention is to provide a rotating sign that includes an illumination source.

A further object of the present invention is to provide a rotating sign using transparent display graphics.

Yet a further object of the present invention is to provide a rotating sign using self-illuminating display surface.

Other objects, features, and advantages of the invention will be apparent from the following detailed description taken in connection with the accompanying drawings.

### BRIEF DESCRIPTION OF THE DRAWING

FIG. 1 is full view of an assembled information display of the present invention.

FIG. 2 is an exploded top view of the information display of the present invention.

FIG. 3 is an enlarged exploded top view of the information displays top support mount and related components of the present invention.

FIG. 4 is an enlarged exploded side view of the information displays top support mount and related components of the present invention.

FIG. 5 is a full view of an assembled information display with the display panel removed showing the illumination source of the present invention.

FIG. 6 is an enlarged view of the bottom of an assemble information display with the display panel removed showing the illumination source of the present invention.

FIGS. 7A and 7B is a plain view of the top and bottom covers of an information display of the present invention.

FIG. 8 is a partial cross-sectional view of the top of the assemble information display of the present invention.

FIG. 9 is the top view of an assembled information display of the present invention.

FIG. 10 is a sectional view of the assembled information display of the present invention.

FIG. 11 is a sectional view showing the female connector of the display support panel of the present invention.

FIG. 12 is a sectional view showing the male connector of the display support panel of the present invention for interlocking with the female end shown in FIG. 11.

FIG. 13 is a top view of the assembled bottom brackets of the present invention.

### DETAILED DESCRIPTION

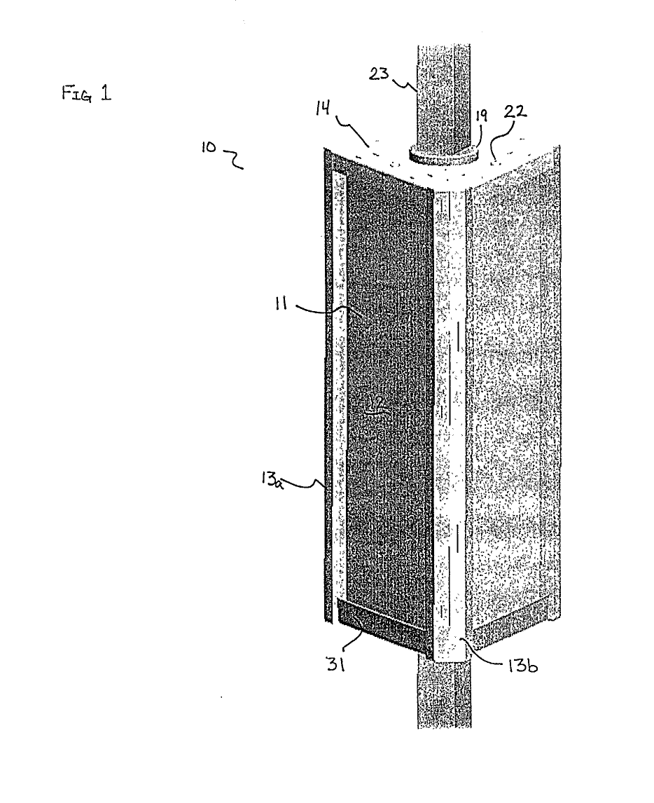

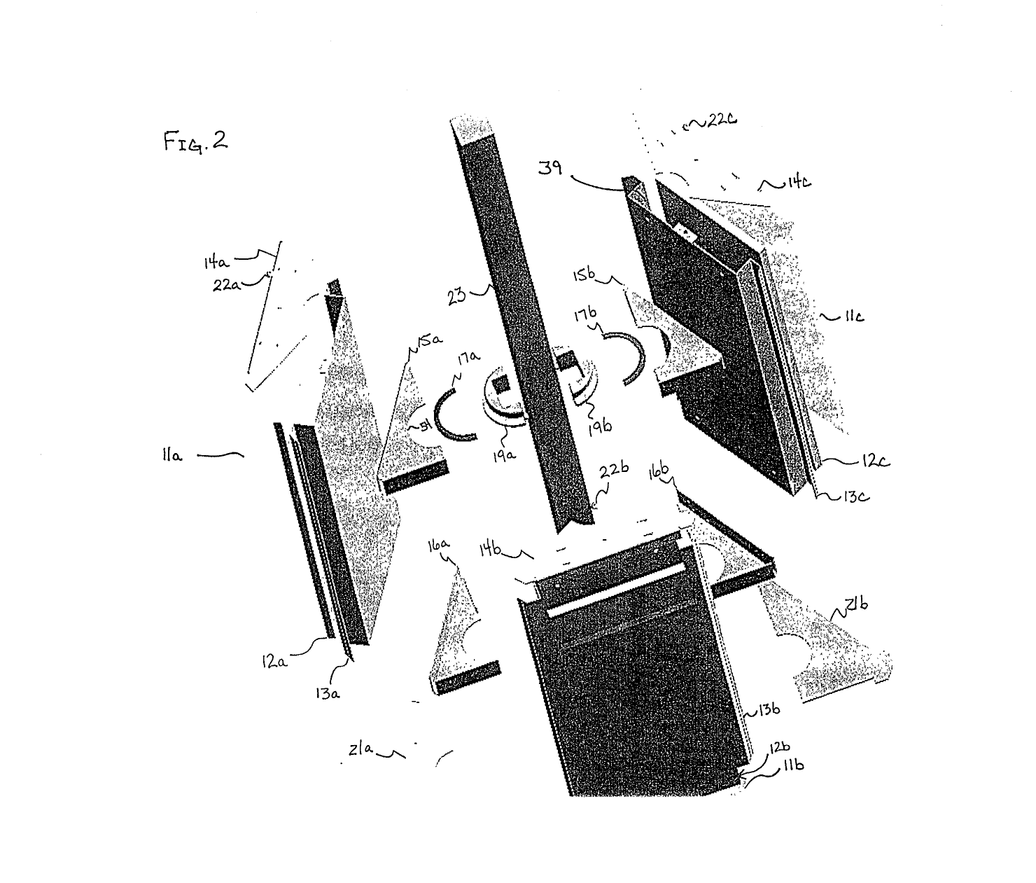

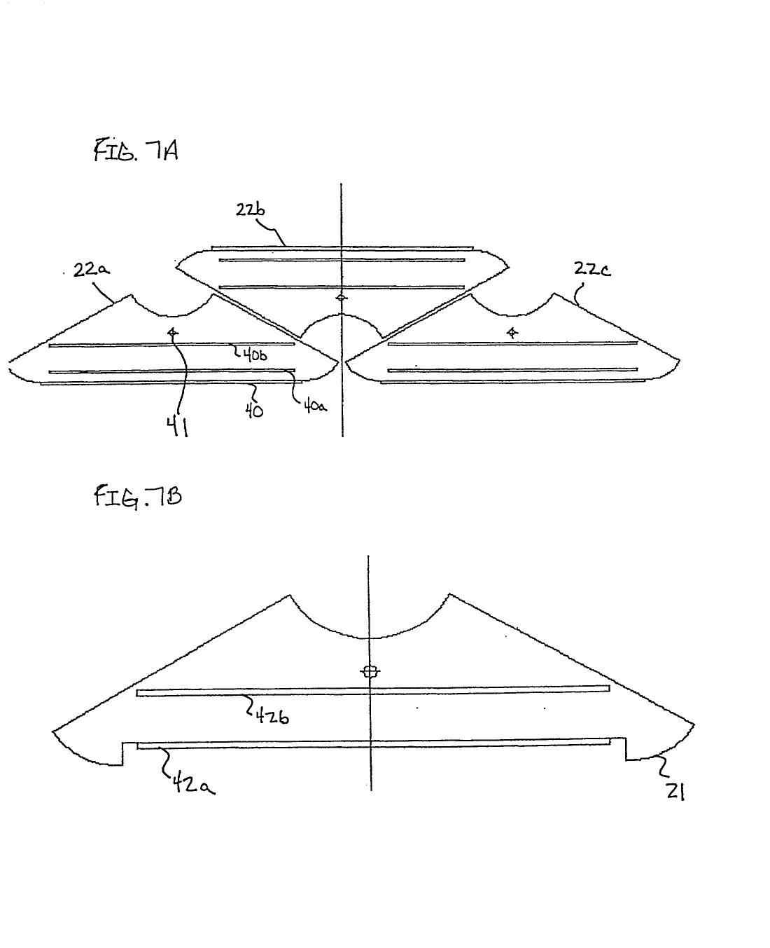

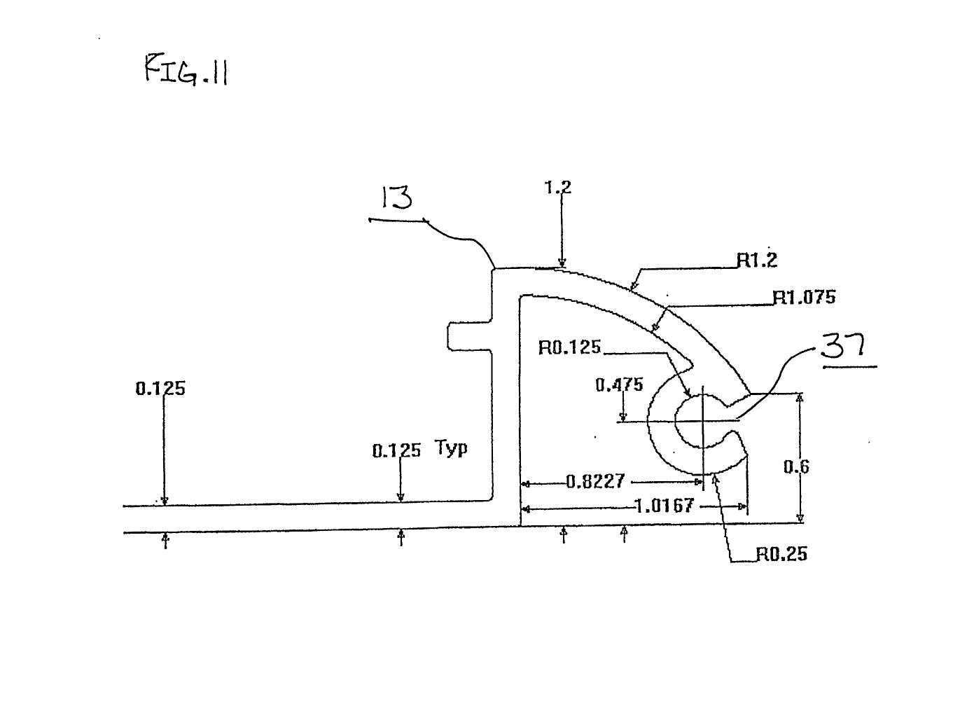

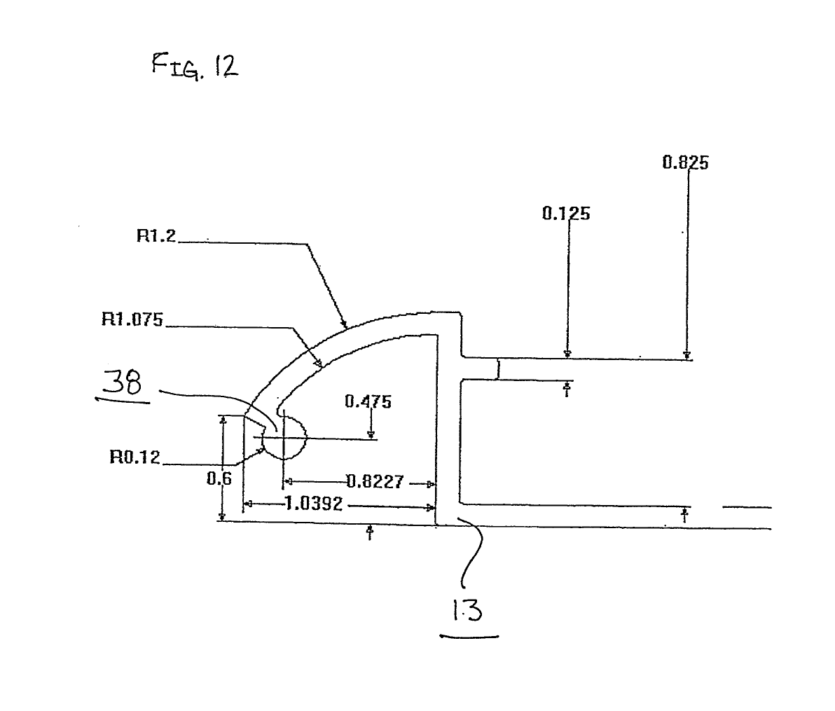

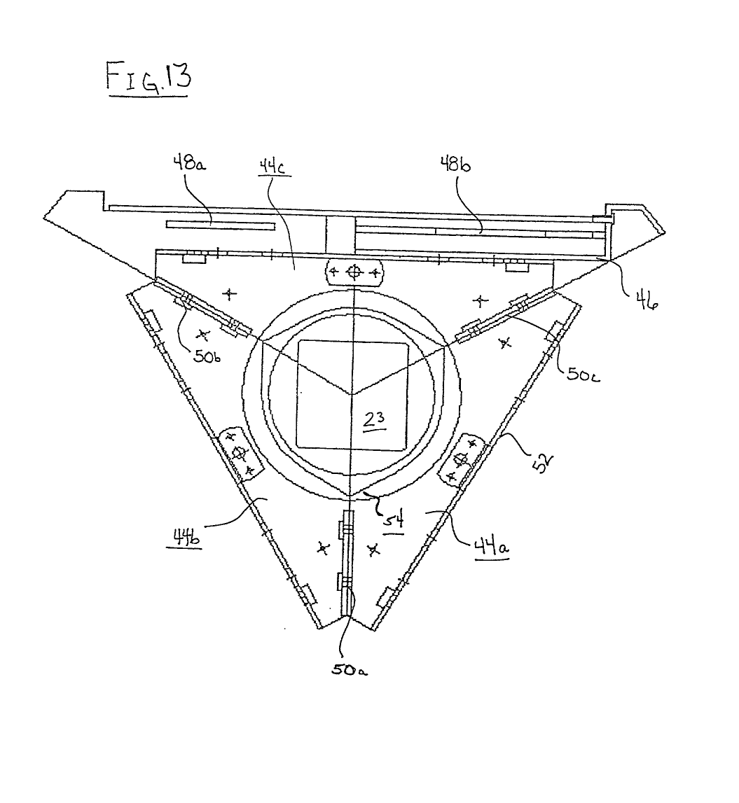

Referring to FIGS. 1 through 13, the reference numeral (10) indicates generally a rotating information display assembly embodying this invention. In its assembled condition, illustrated in FIG. 1, the display assembly (10) comprises a frame formed by three interlocking display support panels (13a-c) connected to support brackets (14a-b and 15a-b, shown in FIG. 2, and 44a-b shown in FIG. 13). The support brackets have an arcuate portion 54 that is configured to engage and encircle support mounts (19 and 20, as shown in FIG. 2), which are detachably fastened to a support member (23). Each support panel (13a-c) includes a panel holder (31) for supporting window panels (11) and display panels (12), which are visualized through the window (11). As shown in FIG. 2, brackets (14a-b and 15a-b) provide rotatable engagement between the support panels (13a-c) and the support mounts (19 and 20; it is to be understood that reference to the top support mount 19 is intended to also make reference to the bottom support mount, where the bottom support mount 20 is not specifically referred to). As illustrated, support panels (13a-c) are secured to brackets (15a-b and 16a-b) to form a framed assembly that is positioned in a rotating configuration about the support member (23). The top and bottom of the assembly (10) is provided with top (22a-c) and bottom (21a-b) covers, which are secured with top fasteners (22a-c) and bottom fasteners (not shown), respectively. As shown in FIG. 2, the bottom cover (21a-b) is comprised of two panels. It is preferable, however, that the bottom cover (21) comprise three panels, each dimensioned as the panel (21) shown in FIG. 7B, which is discussed in more detail below. Once assembled, the information display can be rotated in either a clockwise or counter clockwise direction about the support member (23). In this way, the user of the display can view three different maps or sets of information if each display panel (12a-c) is different.

Referring to FIG. 2, an exploded view of the present invention shows the component parts of the present invention. As illustrated, the preferred support mount (19a-b) comprises two matching halves (19a-b) dimensioned to rigidly fasten to a support member (23). In a preferred embodiment, mounts (19 and 20) are dimensioned to engage with square or round support members (23) having a diameter of 2-inches. It should be understood, however, that support mounts (19 and 20) can be constructed to engage with support members (23) of varying cross-sections. For example, the mount can be dimensioned to engage with a rounded member, rectangular member, or other shaped member, having a diameter of greater or lesser than 2-inches. It is preferable to fabricate mounts (19 and 20) from cast aluminum; however, other materials can be used without deviating from the scope of the invention. For example, the mounts (19 and 20) can be fabricated from plastic, nylon, or other like polymer material.

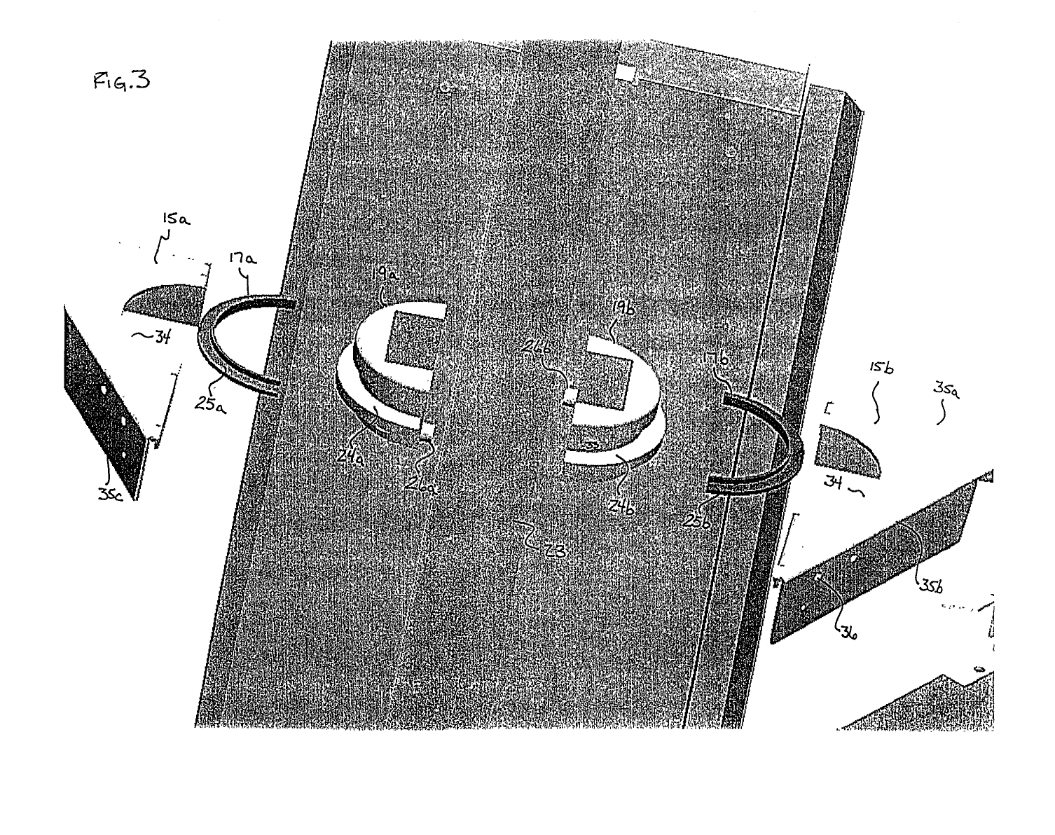

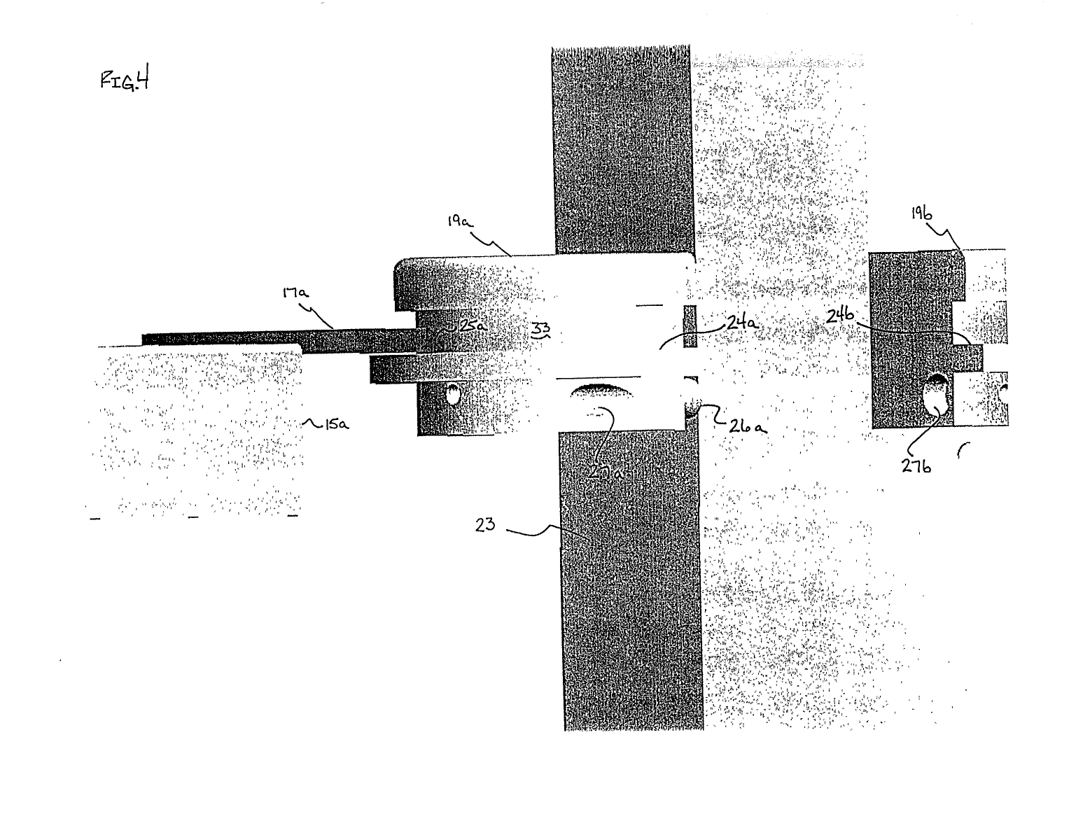

As better illustrated in FIGS. 3 and 4, each support mount halve (19a-b) is provided with fastener passages (27a-b) that mate with the opposing mount halve by way of interlocking members (26a-b). The mount halves are further secured using screws or other similar attachment means inserted through the fastener passages (27a-b) and engaged with the opposing support mount halve. The mount (19 and 20) is therefore easily installed onto an existing support member (23) by simply positioning the mount, inserting the appropriate fasteners and engaging the opposing mount halve. Though the preferred mount (19) is shown as two connecting halves (19a-b), other combination mounts can be used without deviating from the scope of the present invention.

As shown in FIGS. 3 and 4, each mount halve (19a-b) is further provided with a bracket bearing support surface (24a-b). As illustrated, the support surface (24a-b) is disposed adjacent to a semi-circular bearing channel (33) extending about the outer surface of the mount (19a-b). The channel (33) forms a circular bearing channel about the mount (19) when both mount halves (19a-b) are fastened to the support member (23). The bearing channel (33) is dimensioned to receive bracket bearing (17). As shown, the bracket bearing (17) is also comprised of two halves (17a-b), however, the bearing (17) can be fabricated as a single discontinuous circular bearing such that the bearing (17) can be fitted about the mount (19). The bracket bearing (17) is preferably fabricated from plastic, nylon, or other like polymer material.

Referring to FIGS. 3, 4 and 8, the bracket bearing (17a-b) is positioned adjacent to the bearing support surface (24a-b), and the respective brackets (15a-b) are positioned atop the bracket support surface (25a-b) of the respective bracket bearings (17a-b). As shown in FIGS. 2 and 3, the top bracket (15a-b) is comprised of two separate halves, which are connected to form a unitary bracket (15) having a circular inner surface (34) that is positioned within the channel (33) encircling the mount (19), and an outer surface defining three sides (35a-c). Each side (35a-c) includes a plurality of fastening holes (36) for attachment to support panels (13a-c). The assembled bracket (15) rotates within the channel (33) about the mount (19) in an uninterrupted clockwise or counterclockwise circle. In this manner, a sign user is able to rotate by hand the display assembly (10), thus readily accessing multiple display panels (12). Further, the multi-sided framed assembly (10) allows multiple display signs to be presented in a single location without requiring multiple support members or excess walled space.

It should be understood that bottom bracket (16a-b) is assembled in the same manner as disclosed for top bracket (15), and utilizes the same components in the same manner. Such dual construction reduces extra labor and cost that would otherwise be required for parts having separate dimensions and assembly requirements. Brackets (15 and 16) are preferably fabricated from sheet metal or cast aluminum. Other materials can be utilized, however, without deviating from the scope of the present invention. For instance, brackets could be fabricated from light weight composite materials well known in the art.

Referring to FIG. 13, there is shown another embodiment for the bottom brackets (44a-c) and bottom panel (46), which is a panel design similar to that shown in FIGS. 7A-B. As shown, three brackets (44a-c) are specially configured to fit about the mounts secured to the support member (23). To assemble the brackets (44a-c), the brackets are bolted together at connecting flanges (50a-c). Once the brackets are assembled, support panels (13a-c) are bolted along the outer surface (52) of the bracket. In this embodiment, two of the brackets (44a-b) are joined together and two of the panels (13a-b) are connected to the brackets along the bracket outer surface (52). This portion of the sign is then positioned on the support member (23) by positioning the arcuate portion (54) of the brackets about the mounts (19 and 20). Once the brackets (44a-b) are positioned about the mounts (19 and 20), the final and opposing bracket (44c) is bolted to the two brackets (44a-b) at connecting flanges (50b-c). Again, it is to be understood that the same bracket configuration is used for the top brackets (not shown).

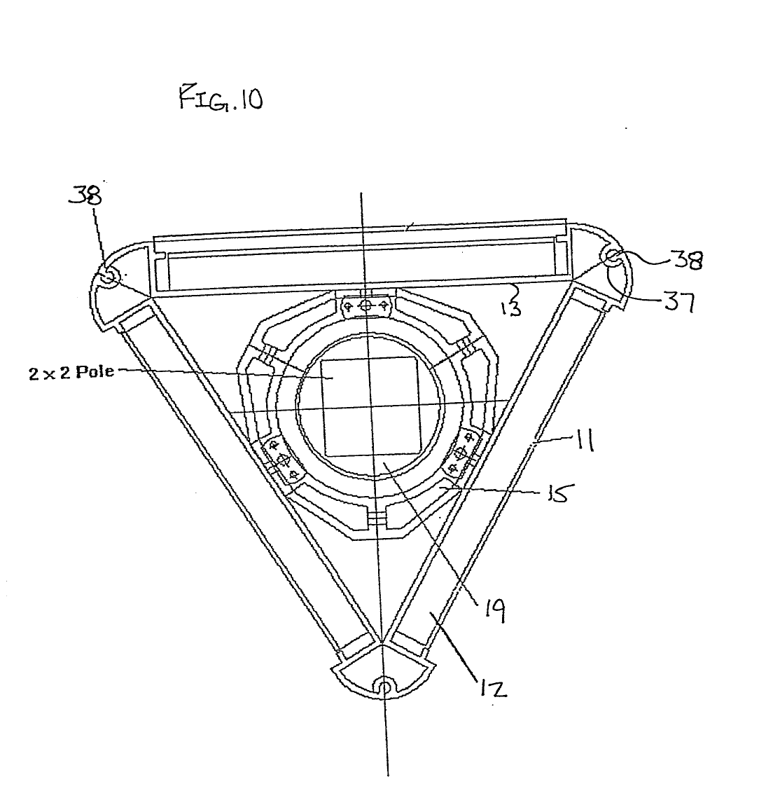

Referring to FIG. 2, the display support panels (13a-c) are shown detached from the top (15) and bottom (16) brackets. Connecting brackets (15 and 16) form a triangle bracket structure having three sides (35a-b). Each display support panel (13a-c) is attached to one of the bracket sides (35a-b), respectively. As illustrated in FIGS. 10-12, it is a preferred embodiment that the opposing vertical edges of the panels (13a-c) have interlocking female (37) and male (38) connectors. In this embodiment, the female and male connectors extend from the top of the panel to the bottom of the panel along the opposing vertical edges of each panel (13a-c). In this way, the female connector (37) of the first panel (13a) is interlocked with the male connector (38) of the second panel (13b). The opposing female connector (37) of the second panel (13b) is configured to interlock with the male connector (38) of the third panel (13c). The female connector (37) of the third panel (13c) then interlocks with the male connector (38) of the first panel (13a), such that a triangular frame is assembled. This interlocking assembly provides panels that can be fastened together so as to form a self-supporting assembly. As such, the interlocking panels provide a sign that is durable and strong. Panels (13a-c) of the display assembly (10) are therefore supported by interlocking connectors (37 and 38), as well as brackets (15 and 16) by way of bracket fastener holes (36) and panel fastener holes (32, shown in FIG. 7). The display support panels (13a-c) are preferably fabricated of extruded aluminum or sheet metal. Other fabrication materials, or combinations thereof, can be used without deviating from the scope of the present invention.

With reference to FIG. 2, panels (12a-c) and windows (11a-c) are inserted into compartment (39) and maintained therein. Changing out a display panel (12a-c) or window (11a-c) merely requires removal of the top fastener (22a-c) used to secure the top cover (14a-c) over compartment (39). After removing the top cover (14), the particular panel (12) or window (11) is simply lifted up and away from the assembly (10). Replacing a panel (12) or window (11) merely requires the reverse of removing a panel (12) or window (11).

As illustrated in FIG. 2, display panels (12a-c) are preferably positioned between support panels (13a-c) and window panels (11a-c). Display panels (12a-c) are preferably fabricated of PCV white, a material commonly known in the art. In this way, the PCV white functions as background color for transparent graphics. More particularly, at least a portion of the display surface of display panels (12a-c) includes information displayed in transparent graphic format. Alternatively, the surface of panels (12a-c) can include a photoluminescent material, which provides information display suitable for viewing at night. Specifically, a photoluminescent display is preferred for night-time viewing, especially by individuals who may be sight impaired. A photoluminescent material suitable for use with the present invention is LUNAPlast™, which is sold by Luminex Emergency Safety Products Ltd. located in Coquitlam, British Columbia, Canada. The LUNAplast™ material is comprised of Strontium Aluminate and provides suitable light emission for use with the present invention. Other panel materials suitable for use with the present invention, and well known in the art, include those materials providing frosted, clear, or translucent white panels. As disclosed below, another feature of the present invention is the use of internal illumination. With internal illumination, panels allowing an increase amount of light transmission are preferable.

In another preferred embodiment, display panels (12a-c), or window panels (11a-c), include Braille lettering. Braille letter enables sight impaired sign users to better navigate the routes on which the sign is placed. The preferred embodiment is highly desirable as traditional signs lack this essential feature.

The window panels (11a-c) of the present invention are preferably constructed of a polycarbonate material or tempered glass. It is preferable to utilize a material that is less likely to break or shatter because of its use in public.

In another preferred embodiment, the support panels (13a-c) include one or more openings (not shown) to allow air to convect out of the panel and sign compartment (39). More particularly, the openings function to transmit vapor away from the panel and sign compartment (39) and into the inner compartment defined by the frame of the display apparatus. Particularly, the openings are preferably provided as two round openings substantially near the top edge of each support panel (13a-c). Referring to FIG. 13, there is shown two openings (48a-b) located on the bottom cover (46), which defines the bottom of the window compartment (39). In this way, air convects up through the openings (48a-b) on the bottom of the window compartment (39), through the window compartment (39), and out through the openings at the top of the support panels (13a-c). This embodiment therefore provides a means for transmitting vapor out of the window compartment (39) that would otherwise fog the window and prevent proper use of the sign. It should be understood, however, that openings of various dimensions can be used without deviating from the scope of the present invention.

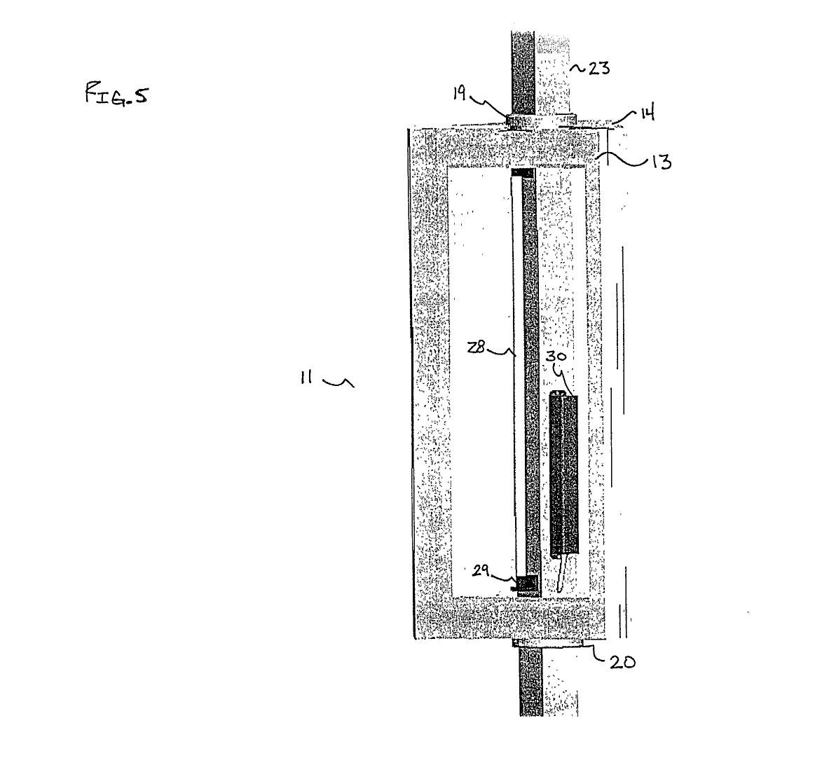

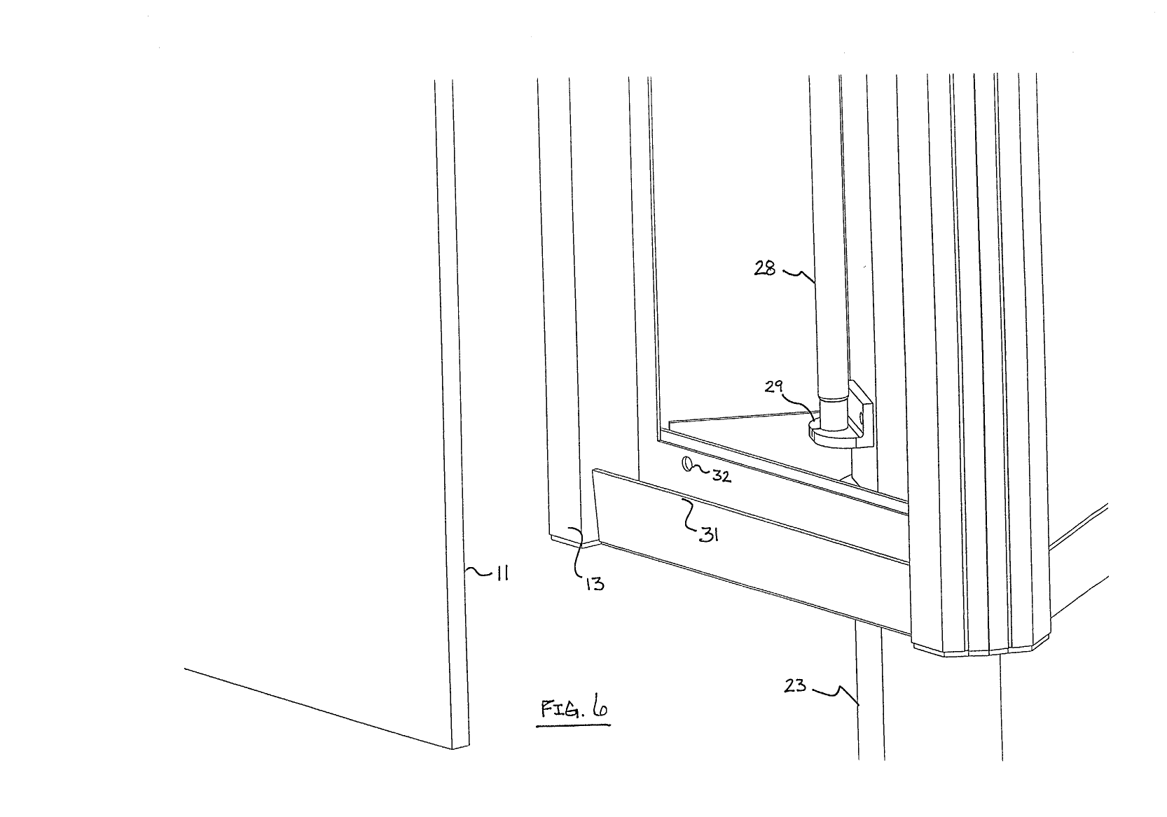

As shown in FIGS. 5 and 6, another embodiment of the present invention is the use of an electrical illumination source to further illuminate the information display panels (12). As illustrated, assembly (10) is shown with display panel (12) removed. In this preferred embodiment, a light source (28) is supported by electrical mounts (29) fastened to the support member (23). Alternatively, the light source could be mounted to the assembly (10) itself. A preferred light source is the T2 fluorescent light bulbs sold by Sylvania. As shown in FIG. 5, an electronic ballast (30) is provided. Suitable electronic ballasts (30) can be purchased from SLI Lighting having a mailing address of 1770 Commerce Park Drive, El Paso, Tex. 79912. In this embodiment, the light source (28) is either retrofitted to an existing support member (23) or the light source (28), support member(23) and assembly(10) are provided together as one unit. The light source (28) of the present invention is further enhanced using a reflective surface (not shown) positioned so as to maximize illumination of the assembly (10). It is preferable that with an internal light source, the support and display panels be fabricated of a substantially translucent material.

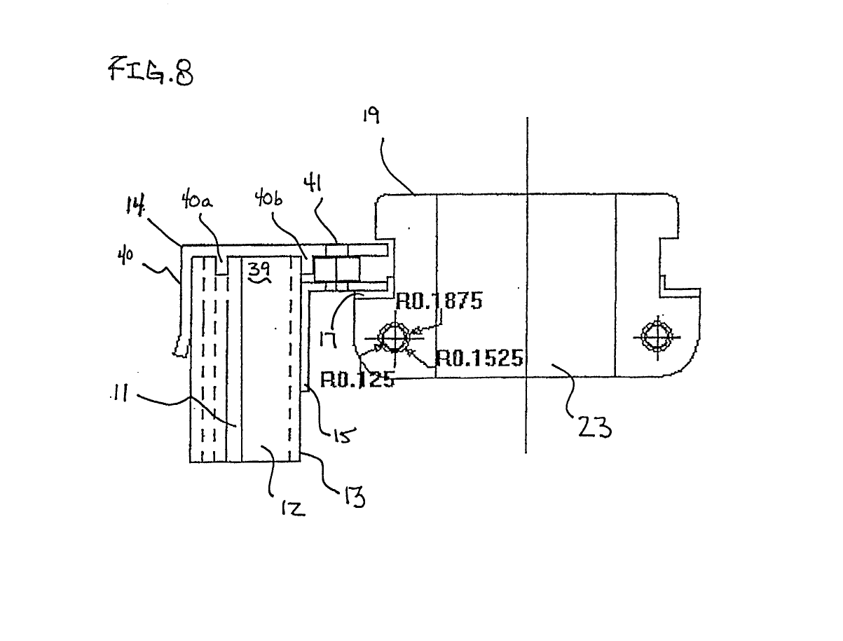

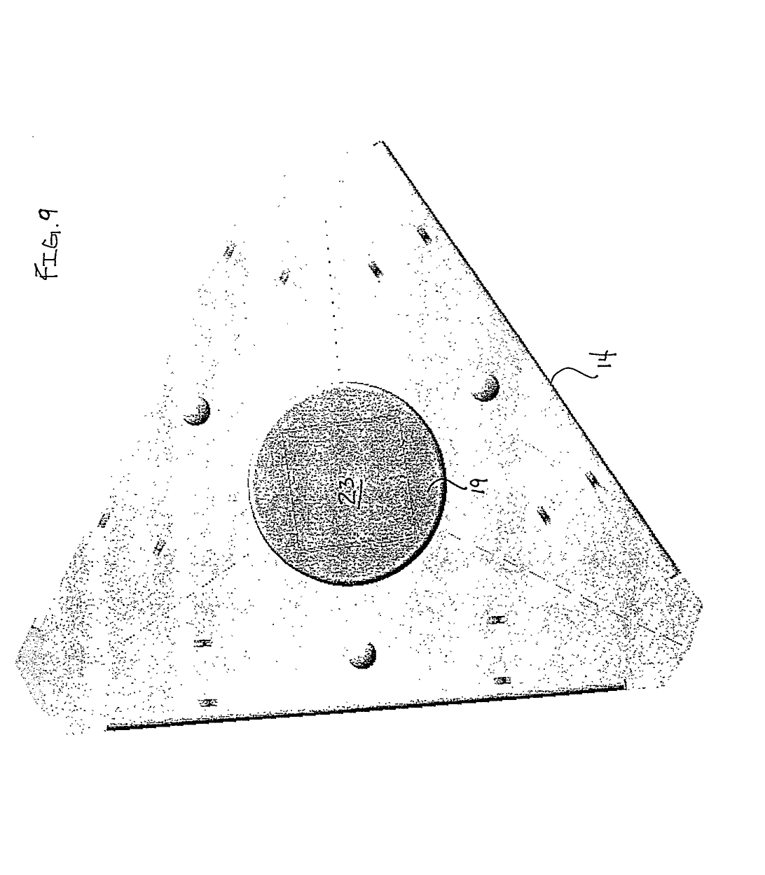

Referring to FIG. 9, there is shown a top view of the assembly (10). As illustrated in FIG. 7A, the top cover is preferably comprised of three separate panels. In a preferred embodiment, each panel (14a-c) includes a front (40a) and back (40b) support rib for holding and maintaining the respective panels (12) and windows (11) in proper orientation. A drip lip (40) is provided to prevent water or other liquids from entering into the panel (12) and window (11) compartment (39). In use, the respective display panels (12) and windows (11) are placed into the panel compartment (39), and the top cover (14) is secured to the top of the assembly (10) by securing panels (14a-c) to the top bracket (15a-b) with fasteners through fastener holes (41). As illustrated in FIG. 8, ribs (40a-b) support window (11) and display panels (12) against support panels (13) within a panel compartment (39).

Referring to FIG. 7b, one of three panels (21) comprising the bottom cover is shown. As shown, the bottom panel (21) includes front (42a) and back (42b) ribs aligned with the front (40a) and back (40b) ribs of the top cover panels (14a-c). In this way, the panels and windows are properly aligned and maintained in the panel compartment (39).

In an alternative embodiment, shown in FIG. 7, each support panel (13a-c) includes a compartment (39) support platform (31). In this way, display panels (12) and windows (11), or any combination thereof are inserted into compartment (39), moved downward along panel (13), and placed in resting position within support platform (31).

The foregoing detailed description has been given for clearness of understanding only and no unnecessary limitations should be understood therefrom as some modifications will be obvious to those skilled in the art without departing from the scope of the presently disclosed invention.

I claim:

1. A display apparatus comprising:
at least one mount adapted to detachably fasten to a support member, said mount adapted to receive at least one bearing;
at least one bearing positioned substantially adjacent said at least one mount;
at least one bracket having a first end positioned substantially adjacent said at least one mount;
at least one panel secured to a second end of said rotatable bracket;
at least one information displaying panel adjacent the panel; and
wherein, said at least one bracket is rotatable about said mount, whereby said at least one information displaying panel is rotatable about said support member.

2. The apparatus as defined in claim 1, wherein the at least one panel comprises three or more panels, the panels adapted to interconnect so as to form a triangular frame, wherein the triangular frame is positioned about said support member.

3. The apparatus as defined in claim 1, wherein said information display panel includes an information display surface.

4. The apparatus as defined in claim 3, further including a substantially transparent window panel positioned adjacent to the information displaying panel.

5. The apparatus as defined in claim 2, wherein said panels comprise an information display surface.

6. The apparatus as defined in claim 1, wherein said information display panels are interchangeable.

7. The apparatus as defined in claim 1, wherein said information displaying panels include Braille lettering.

8. The apparatus as defined in claim 1, wherein at least a portion of said information displaying panel is self-illuminating.

9. The apparatus as defined in claim 2, further including an illuminating source.

10. The apparatus as defined in claim 9, wherein said illuminating source is positioned within the triangular frame.

11. The apparatus as defined in claim 8, wherein said information displaying panel has a surface made from a self-illuminating material comprising Strontium Aluminate.

12. A display apparatus comprising:
at least one mount detachably fastened to a support member, said mount adapted to receive at least one bearing;
at least one bearing positioned substantially adjacent said at least one mount;
at least one bracket having a first end disposed substantially adjacent said at least one bearing and said at least one mount, said at least one bracket rotatable about said mount;
a frame secured to a second end of said at least one bracket, said frame for holding a plurality of panels;
a plurality of panels; and,
wherein, said panels are adapted to communicate information, said panels being rotatable about the support member.

13. The apparatus as defined in claim 12, further including a substantially transparent panel positioned adjacent to at least one of said plurality of panels.

14. The apparatus as defined in claim 13, wherein at least a portion of said transparent panel is fabricated of polycarbonate or tempered glass material.

15. The apparatus as defined in claim 12, wherein at least a portion of said panel has raised Braille lettering.

16. The apparatus as defined in claim 13, wherein at least a portion of said transparent panel has raised Braille lettering.

17. A display apparatus comprising:
a support member;
an illumination source attached to said support member;
at least one mount securedly fastened to said support member, said mount adapted to receive at least one bearing;
at least one bearing positioned substantially adjacent said at least one mount;
at least one bracket having a first end disposed between said at least one bearing and said at least one mount, said bracket rotatable about said mount;
a frame supported by said rotating bracket, said frame configured about said support member; said frame having at least one side adapted to receive one or more display panels;
at least one display panel supported by said frame; and,
wherein, said frame includes an inner compartment enclosing at least a portion of said support member, and said illumination source is attached to said portion of said support member that is located within said inner compartment of said frame.

18. The apparatus as defined in claim 17, wherein the illumination source is an electrical light source.

19. The apparatus as defined in claim 17, further comprising an illumination panel having a reflective surface disposed adjacent said illumination source.

20. A display apparatus comprising:
a frame, said frame having at least one outer surface adapted to display information;
at least one bracket having a first end for engaging an inner surface of said frame, and a second end for rotatably linking said frame to a support mount detachably mounted to a support member;
a bearing disposed between said second end of said bracket and said support mount; and,
wherein, said frame is adapted to be rotated about said support mount by turning the frame such that said bracket is rotatably engaged with said mount, whereby said frame rotates about the support member.

21. The apparatus as defined in claim 19, wherein at least a portion of said frame outer surface is self-illuminating.

22. The apparatus as defined in claim 19 further including one or more transparent panels disposed substantially adjacent to said frame outer surface.

23. The apparatus as defined in claim 22, wherein said transparent panel is made of polycarbonate or tempered glass.

24. The apparatus as defined in claim 19, further including an illumination source located substantially adjacent said inner surface of said frame.

25. A display apparatus comprising:
at least one mount having an inner surface securedly fastened about the outer surface of a support member, said mount having an outer surface adapted to receive at least one bearing;
at least one bearing positioned substantially adjacent said outer surface of said at least one mount;
at least one bracket having a first end disposed substantially between said at least one bearing, said bracket rotatable about the outer surface of said mount;
a frame having an inner surface secured to a second end of said rotatable bracket; said frame having three or more outer support panels adapted to support information displaying panels;
a plurality of information display panels; and,
wherein, rotation of said bracket about the outer surface of said mount rotates said frame about said support member so as to rotate said information display panels about said support member.

26. A method for displaying information, said method comprising the steps of:
providing a moveable panel having a plurality of display surfaces;
providing information on one of said display surfaces; and,
rotating said panel such that said display surface is in view.

27. The apparatus as defined in claim 17, wherein the side of the frame defines at least one opening therethrough to transmit vapor away from the display panel and into the inner compartment of the frame.

28. The apparatus as defined in claim 27, further including a display panel support surface, the support surface defining at least one opening therethrough so as to provide air convection between the support surface opening and the opening defined by the side of the frame.

29. The apparatus as defined in claim 25, wherein the outer support panels of the frame have an outer surface forming at least one opening therethrough to transmit vapor away from the information display panels.

30. The apparatus as defined in claim 2, wherein each of said panels has opposing first vertical and second vertical edges, the first vertical edge having a female connector and the second vertical edge having a male connector, wherein the panels are adapted to interlock along their respective vertical edges so as to form a triangular frame.
